(19) United States
(12) Patent Application Publication
(10) Pub. No.: US 2011/0028098 A1
(43) Pub. Date: Feb. 3, 2011

(54) COGNITIVE RADIOS FOR SECURE TRANSMISSIONS

(76) Inventors: Gokhan Memik, Evanston, IL (US); Seda Ogrenci Memik, Evanston, IL (US); Bill Mangione-Smith, Kirkland, WA (US)

Correspondence Address: EVAN LAW GROUP LLC, 600 WEST JACKSON BLVD., SUITE 625, CHICAGO, IL, 60661, US

(21) Appl. No.: 12/512,014

(22) Filed: Jul. 29, 2009

(51) Int. Cl. H04B 17/00; H04B 1/04

(52) U.S. Cl. 455/62; 455/120

(57) ABSTRACT

In accordance with various embodiments, methods, systems and apparatuses for transmitting communications are generally described. Initial information to be transmitted with initial transmission characteristics can be received. Spectrum holes can be found in the communication signal spectrum. The initial communication having initial transmission characteristics can be converted into a new communication including the initial information and new transmission characteristics. The new transmission characteristics are different from the initial transmission characteristics, where the new communication can be transmitted at one or more frequencies identified with the spectrum holes.

### REFERENCE To RELATED APPLICATIONS

This application is related to the following co-pending applications, application Ser. No. ______ (Attorney Docket No. LLV01-004-US) entitled “Location and Time Sensing Cognitive Radio Communication Systems” filed ______; application Ser. No. ______ (Attorney Docket No. VCS01-005-US) entitled “Spectrum Sensing Network For Cognitive Radios” filed ______; application Ser. No. ______ (Attorney Docket No. KLV01-006-US) entitled “Reputation Values in A Spectrum Sensing Network” filed ______; application Ser. No. ______ entitled “Secure Cognitive Radio Transmissions” (Attorney Docket No. BCV01-007-US) filed ______; and application Ser. No. ______ (Attorney Docket No. FDV01-009-US) entitled “Spectrum Sensing Network For Cognitive Radios” filed ______.

### BACKGROUND

The electromagnetic radio spectrum is a natural resource, the use of which by transmitters and receivers is licensed by governments. In many bands, spectrum access is a more significant problem than physical scarcity of spectrum, in large part due to legacy command-and-control regulation that limits the ability of potential spectrum users to obtain such access. Indeed, if portions of the radio spectrum were scanned, including in the revenue-rich urban areas, one would find that some frequency bands in the spectrum are largely unoccupied most of the time; some other frequency bands are only partially occupied; and the remaining frequency bands are heavily used.

The underutilization of the electromagnetic spectrum has lead to the view that spectrum holes within the electromagnetic spectrum exist. As used herein, a spectrum hole exists when a band of frequencies assigned to a primary user is not being utilized by that user, at a particular time and specific geographic location. By making it possible for a secondary user to access the band of frequencies within a spectrum hole, utilization of the electromagnetic spectrum can be improved. A cognitive radio, inclusive of software-defined radio, has been proposed as a means to promote the efficient use of the electromagnetic spectrum by exploiting the existence of spectrum holes.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 depicts a cognitive radio;

FIG. 2 depicts a schematic representation of a communications system;

FIG. 3 depicts a schematic representation of a communication and its transmission; and

FIG. 4 depicts a flowchart illustration of methods, apparatus (systems) and computer program products, all arranged in accordance with at least some embodiments of the present disclosure.

### DETAILED DESCRIPTION

The following description sets forth various examples along with specific details to provide a thorough understanding of claimed subject matter. However, it will be understood by those skilled in the art that claimed subject matter may be practiced without some or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The present disclosure generally describes a cognitive radio configured to transmit a communication with characteristics which are other than those traditionally used for that type of communication, allowing for more secure transmission. By transmitting a communication having transmission characteristics which mimic transmission characteristics of another commonly transmitted or licensed communications, it may be possible to hide the type of communication being transmitted, thereby making transmission of the communication more secure. As used herein, transmission characteristics which are “traditional” or “traditionally used” for a particular type of communication include, but are not limited to, the following: transmission characteristics which are most commonly used commercially for that type of communication (such as a frequency at which a particular type of communication is most often transmitted), transmission characteristics which are licensed for that type of communication, transmission characteristics which conform to an industrially accepted standard for that type of communication, and includes transmission characteristics such as a frequency at which a device made to receive that particular type of communication is designed to receive.

In some examples, the present disclosure describes methods for transmitting a first digital or analog communication having information to be transmitted with first transmission characteristics. The method may include determining spectrum holes and converting the first communication into a second communication with the information and second transmission characteristics. The second transmission characteristics may be different from the first transmission characteristics. The second communication may be transmitted at a certain frequency within the spectrum holes.

In some other examples, the present disclosure describes method for communicating in a communications system including a cognitive radio, including a cognitive receiver arranged to process a cognitive task and a cognitive transmitter for transmitting a communication to a communications device. The method may include detecting which radio frequencies are available for use and receiving a first communication with information and first transmission characteristics having a first transmission frequency in the cognitive radio. The method may also include converting the first communication into a second communication with the information and second transmission characteristics having a second transmission frequency. The second transmission frequency may not be the first transmission frequency. The second transmission frequency may be a radio frequency available for use.

In yet other examples, the present disclosure describes methods for operating a cognitive radio. The method may include processing a spectrum sensing task in order to determine which radio frequencies are available for use and receiving a first communication with information and first transmission characteristics using first transmission frequencies in the cognitive radio. The method may also include converting the first communication into a second communication with the information and second transmission characteristics using a second transmission frequency. The second transmission frequency may not be any of the first transmission frequencies. The second transmission frequency may be a radio frequency available for use.

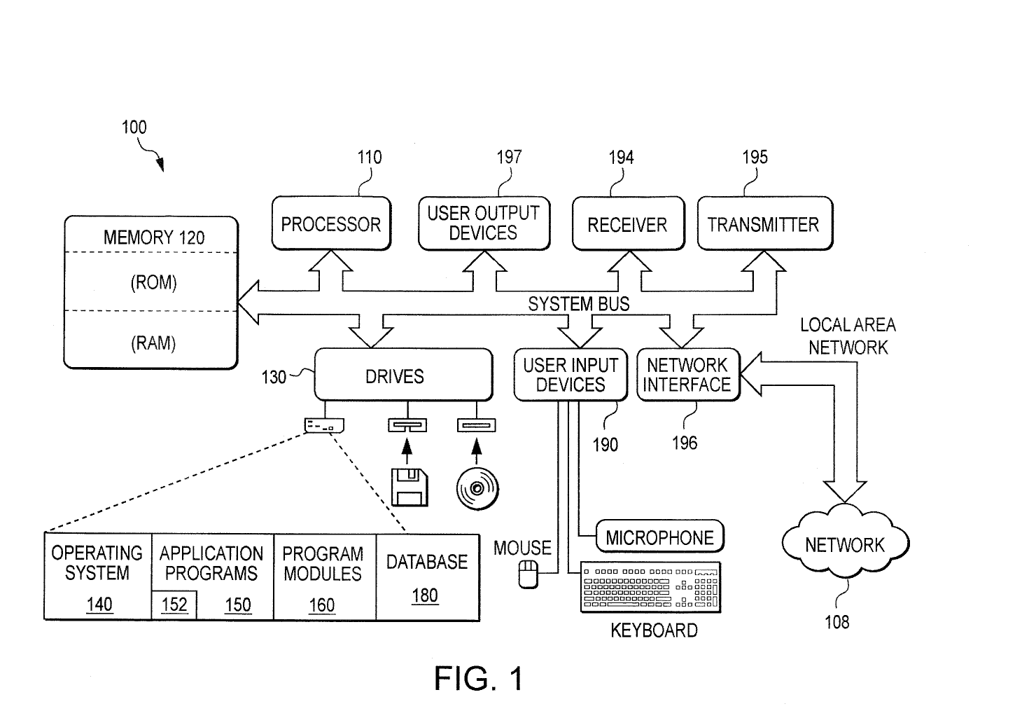

FIG. 1 depicts a cognitive radio for implementing some embodiments in accordance with the present disclosure. As shown in FIG. 1, a cognitive radio 100 may include a processor 110, a memory 120 and one or more drives 130. The drives 130 and their associated computer storage media may be arranged to provide storage of computer readable instructions, data structures, program modules and other data for the cognitive radio 100. Drives 130 can include stored there on one or more of an operating system 140, application programs 150, program modules 160, and a database 180.

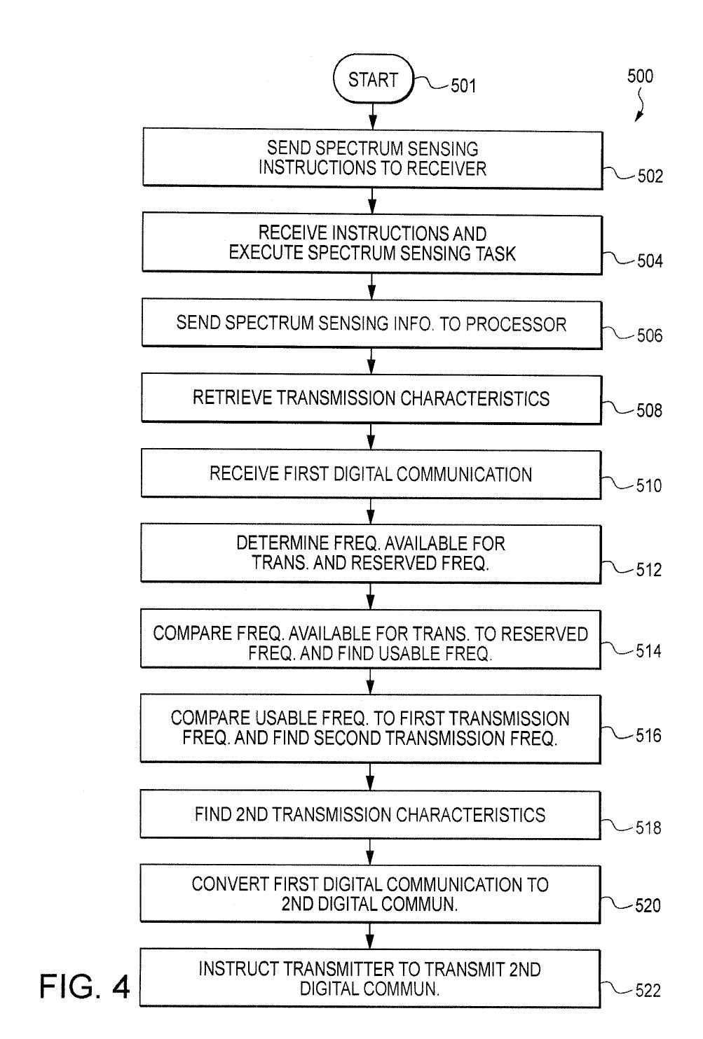

Application programs 150, for example, may include an application program containing program instructions for causing a cognitive radio 100 to carry out the functions specified in FIG. 4, for example a method of transmitting a communication 152. Cognitive radio 100 may further include user input devices 190 through which a user may enter commands and data. Example input devices can include an electronic digitizer, a microphone, a keyboard and a pointing device, commonly referred to as a mouse, trackball or touch pad. Other example input devices may include a joystick, game pad, satellite dish, scanner, or the like.

These and other input devices can be connected to processor 110 through a user input interface that is coupled to a system bus, but may be connected by other interface and bus structures, such as a parallel port, game port or a universal serial bus (USB). Cognitive radio 100 may also includes a receiver 194 through which radio frequency signals are received and a transmitter 195 through which radio frequency signals are transmitted. Cognitive radio 100 with receiver 194 and without transmitter 195 will be referred to herein as a cognitive receiver, and cognitive radio 100 with transmitter 195 and without receiver 194 will be referred to herein as a cognitive transmitter. In some embodiments, the cognitive radio 100 includes a transceiver, instead of receiver 194 and transmitter 195, wherein the transceiver operates as both a transmitter and a receiver.

Cognitive radio 100 may operate in a networking environment using connections to one or more computers, such as a remote computer connected to network interface 196. The remote computer may be a personal computer, a server, a router, a network PC, a peer device or other common network node, and can include some or all of the elements described above relative to cognitive radio 100. Networking environments are commonplace in offices, enterprise-wide area networks (WAN), local area networks (LAN), intranets and the Internet.

For example, cognitive radio 100 may be the source from which data is being migrated, and the remote computer may be the destination to which the data is being migrated, or vice versa. Note, however, that the source and destination need not be connected by a network 108 or any other means, but instead data may be migrated via any media capable of being written by the source and read by the destination. When used in a LAN or WAN networking environment, cognitive radio 100 may be connected to the LAN through a network interface 196 or an adapter. When used in a WAN networking environment, cognitive radio 100 typically may include a modem or other means for establishing communications over the WAN, such as the Internet or network 108. It will be appreciated that other means of establishing a communications link between the source and destination may be used. Cognitive radio 100 may also be connected to user output devices 197 for outputting information to a user. User output devices 197 may include a display, a printer and speakers.

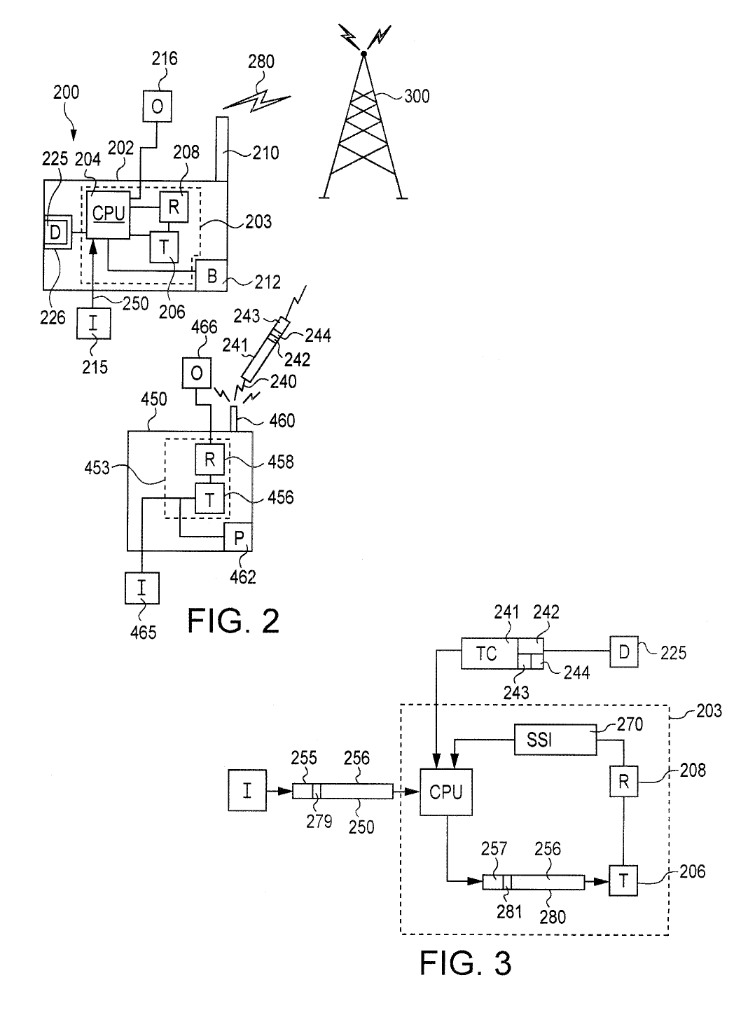

FIG. 2 depicts a schematic representation of a communications system, arranged in accordance with at least some embodiments of the present disclosure. As shown in FIG. 2, a communications system 200 is provided in accordance with at least some embodiments of the present disclosure. The communications system 200 may include a communications device 202 in communication with another communications device 450 and a transmission tower 300 for relaying communications between communications devices 202 and 450. The communications device 202 may be any suitable device, such as wireless telephones, radios, and hand-held two-way radio transceivers, which may transmit and/or receive RF signals. The communications device 202 may include a cognitive radio 203, an antenna 210, and a power source 212. The cognitive radio 203 may be a wireless communication device configured to change its transmission or reception parameters to communicate efficiently and avoid interference with licensed or unlicensed users of other communications devices, such as communications device 450. The cognitive radio 203 may be configured to perform cognitive tasks, which may be the alteration of parameters based on the active monitoring of several factors in the external and internal radio environment, such as radio frequency spectrum, user behavior and network state. The cognitive tasks performed by cognitive radio 203 may begin with the passive sensing of RF stimuli, called spectrum sensing. The following are some examples of other optional cognitive tasks performed by cognitive radio 203: (1) radio-scene analysis, which may encompass: (a) estimating interference temperature (a metric which quantifies sources of interference in a radio environment); and/or (b) detecting spectrum holes, by spectrum sensing; (2) channel identification, which may encompass: (a) estimation of channel-state information; and/or (b) prediction of channel capacity for use by the transmitter; and/or (3) transmit-power control and dynamic spectrum management.

Cognitive radio 203 functionally can include substantially all the components of cognitive radio 100, as described herein. Cognitive radio 203 may include at least one processor 204 arranged in communication with a receiver 208 and optionally a transmitter 206. In some examples, transmitter 206 and receiver 208 can be replaced with a transceiver. Processor 204 may be arranged to send cognitive instructions to both the receiver 208 and transmitter 206 and may be adapted to receive cognitive information, such as spectrum sensing information 270 (see FIG. 3), from the receiver 208 when performing and processing cognitive tasks, such as spectrum sensing tasks.

Receiver 208 may be arranged to receive RF signals, from antenna 210 and transmitter 206 transmits RF signals through antenna 210. Antenna 210 may be adapted to transmit or receive RF signals to/from transmission tower 300, which then may broadcast these RF signals either via land lines or other RF signals, to other communications devices, which may include wireless communications devices such as communications device 450, or wired communications devices such as telephones. Antenna 210 can also be adapted to send RF signals directly to the other communications device 450. Power source 212 may be arranged in communication with and may power cognitive radio 203. Power source 212 may include, for example, a fuel cell, a battery such as a lithium ion battery, and/or a capacitor.

Communications device 202 may include an input device 215 arranged for inputting a first communication 250 received by processor 204. Input device 215 may be arranged in communication with cognitive radio 203, and may include any device which can be used to input information from a user, such as an electronic digitizer, a microphone, a keyboard, and/or a pointing device, commonly referred to as a mouse, trackball or touch pad. Input device 215 may also include a joystick, game pad, satellite dish, scanner, or the like. Communications device 202 may also include an output device 216 for outputting information to a user. Output device 216 may be arranged in communication with cognitive radio 203, and may include any device which can be used to communicate information, such as first communication 250, to a user and may include devices such as a display, a printer, and speakers.

The spectrum-sensing task may be configured to detect spectrum holes, which may be bands of unused radio frequencies in the radio frequency (RF) spectrum available for use by cognitive radio 203. The cognitive radio 203 may be adapted to passively sense the RF spectrum and estimates the power spectra of incoming radio frequency stimuli, in order to classify the RF spectrum into one of three broadly defined types of radio frequencies: (1) black spaces, which may be occupied by high-power “local” interferers some of the time; (2) grey spaces, which may partially be occupied by low-power interferers; and (3) white spaces, which may be substantially free of RF interferers except for ambient noise, made up of natural and artificial forms of noise. Ambient noise may include: broadband thermal noise produced by external physical phenomena such as solar radiation; transient reflections from lightening, plasma (fluorescent) lights, and aircraft; impulsive noise produced by ignitions, commutators, and microwave appliances; and thermal noise due to internal spontaneous fluctuations of electrons at the front end of individual receivers.

White spaces and grey spaces, to a lesser extent, may contain spectrum holes which make good candidates for use by cognitive radio 203. While black spaces are to be avoided when and where the RF emitters residing in them are switched ON, when those emitters are switched OFF, the black spaces assume a new role of “spectrum holes,” and the cognitive radio 203 may provide the opportunity for discovering significant “white spaces” within the unused black spaces by invoking a dynamic-coordination capability for spectrum sharing.

As a result, by conducting a spectrum sensing task, cognitive radio 203 may be able to determine which portion of the RF spectrum contains frequencies that are not being utilized, identifying spectrum holes. Thereafter, receiver 208 within cognitive radio 203 may be arranged to communicate spectrum-sensing information 270, which contains information regarding spectrum holes, to processor 204 within cognitive radio 203. The spectrum sensing information 270 may typically contain bands of frequencies within the white spaces and the grey spaces, however sometimes the bands of frequencies are within the black spaces. Cognitive radios may be described in: Haykin, S. “Cognitive Radio: Brain-Empowered Wireless Communications,” IEEE JOURNAL ON SELECTED AREAS IN COMMUNICATIONS, Vol. 23, No. 2, pp. 201-220 (February 2005).

Communications device 450 may be any device which may transmit communications 240, for example, via RF signals. Communications device 450 may include, for example: Wi-Fi or WiMax transmitters; a cellular phone or cellular transmission tower transmitting cellular signals via EDGE (Enhanced Data rates for GSM Evolution), GSM (Global System for Mobile communications), GPRS (General packet radio service), 2G Cellular networks, and 3G Cellular networks; a television transmitter, such as a HDTV transmitter or transmission tower. Communications device 450 may include a radio 453, an antenna 460, and a power source 462. The radio 453 may be a wireless communication device which is arranged to transmit, and also receive communications via RF signals. Radio 453 functionally can include substantially all the components of cognitive radio 100, as described herein. Radio 453 may include at least one transmitter 456 and optionally a receiver 458. Transmitter 456 and receiver 458 may be replaced with a transceiver (not shown).

Receiver 458 may be configured to receive RF signals, from antenna 460 and transmitter 456 may be configured to transmit RF signals through antenna 460. Antenna 460 can be any device which can be used to receive and transmit RF signals and include devices such as a portable antennas and transmission towers. Antenna 460 may be arranged to broadcast RF signals either via land lines or a transmission tower, to other communications devices which include may wireless communication devices such as communications device 202, or wired communication devices such as telephones, radios, and televisions. Antenna 460 can also be used to directly send RF signals to other communications devices 202. Power source 462 may be arranged in communication with, and power, radio 453. Power source 462 may be wired directly to an electric grid, or may be a portable device, for example, a fuel cell, a battery such as a lithium ion battery, and/or a capacitor.

In some embodiments, communications device 450 may include an input device 465 configured to input a first communication 250 received by radio 453, and specifically, transmitter 456. Input device 465 may be arranged in communication with radio 453, and may include any device which can be used to input information from a user, such as an electronic digitizer, a microphone, a keyboard, and a pointing device, commonly referred to as a mouse, trackball or touch pad. Input device 465 may also include a joystick, game pad, satellite dish, scanner, or the like. In some embodiments, communications device 450 may also include an output device 466 for outputting information to a user. Output device 466 may be arranged in communication with radio 453, and specifically receiver 458, and may include any device which can be used to communicate information to a user, such as first communication 250, and may include devices such as a display, a printer, and speakers.

Communications device 450 may be arranged to transmit and receive communications 240 via transmitter 456 and antenna 460. The communications 240 may have transmission characteristics 241 which can indicate the type of information being transmitted within the communication 240. The type of information being transmitted may be, for example, video information transmitted via analog television transmissions, digital television transmissions, and satellite television transmissions; audio information transmitted via cellular telephone transmissions, analog radio transmissions, digital radio transmissions, satellite radio transmissions, and digital hand-held, two-way radio transceiver transmissions (such as Walkie-Talkie transmissions); and information includes files, internet traffic, and information transmitted through a network, via 802.11 transmissions (such as 802.11a, 802.11b, 802.11g, and 802.11n), Bluetooth™, Wi-Fi, WiMax, EDGE (Enhanced Data rates for GSM Evolution), GSM (Global System for Mobile communications), GPRS (General packet radio service), 3G, 4G, CDMA (Code division multiple access), and Wireless USB transmissions.

The transmission characteristics 241 may include, for example, transmission frequency information 242, handshake information 243, and format information 244. Transmission frequency information 242 may indicate a transmission frequency reserved or which is traditional for transmission of the communication 240. Transmission frequency information 242 can vary depending on the type of information being transmitted within communication 240. For example, in the United States, certain frequencies are reserved for transmitting video information via television transmissions; if a transmission occurs within one of those frequencies then the type of information within that transmission can be assumed to be video information transmitted via television transmissions.

Handshake information 243 may include predetermined hardware or software information designed to establish or maintain two communications devices in synchronization when transmitting information. Handshake information 243 can also vary depending on the type of information being transmitted within communication 240. For example, audio information transmitted via cellular telephone transmissions may have different handshake information 243 than audio information transmitted via radio transmissions. Therefore, if a certain type of handshake information 243 is within communication 240, then it may be assumed that communication 240 is transmitting a certain type of information.

Format information 244 may indicate the manner in which information within the communication 240 has been saved. For example, format information 244 may include file formats such as: .mp3, .wav, and .wmp for audio information; mpeg-1 codec, mpeg-2 codec, and h.264 codec for video information; and text files and Microsoft™ Word files for information including files and internet traffic. For the same type of information, such as audio information, format information 244 may differ depending on the exact type of information being transmitted. For example, audio information being transmitted via cellular telephone transmissions may be transmitted in a different format from audio information being transmitted via radio transmissions, and as a result the format information 244 for audio information being transmitted via cellular telephone transmissions may be different that the formation information 244 for audio information being transmitted via radio transmissions. As a result, format information 244 can be helpful in determining the type of information being transmitted.

In some embodiments, when performing a spectrum-sensing task, processor 204 of communications device 202 may be configured to send cognitive instructions to receiver 208 to scan the RF spectrum for spectrum holes. In turn, receiver 208 may be adapted to send spectrum sensing information 270 to processor 204 identifying spectrum holes. Additionally, processor 204 may access and receive from a database 225 transmission characteristics 241 for a variety of communications 240 being transmitted. Database 225 can be stored locally within a storage unit 226 within communications device 202, as shown in FIG. 2, or database 225 can be stored remotely in a storage unit in another device or network, and accessed remotely.

FIG. 3 depicts a schematic representation of a communication and its transmission. As shown in FIGS. 2 and 3, processor 204 may also be arranged to receive from input device 215 first communication 250 having information 256 to be transmitted using first transmission characteristics 255. First transmission characteristics 255 may not necessarily be part of first communication 250, but rather may be transmission characteristics traditionally used for first communication 250. For example, if communications device 202 is a cellular telephone which transmits audio information via cellular telephone transmissions, then the first transmission characteristics 255 may include first transmission frequencies 279 which are licensed for cellular telephone transmissions are transmitted, along with any handshake protocols that cellular telephone communications use, and in a format used for transmission via a cellular telephone. The first transmission frequencies 279 within the first transmission characteristics 255 typically include a range of frequencies traditionally used for the same type of communication as the first communication 250.

Upon receiving spectrum sensing information 270 and transmission characteristics 241, processor 204 may be configured to determine which frequencies are available for transmission and which frequency ranges are reserved for use by other communications devices, using transmission frequency information 242 within transmission characteristics 241. Frequency ranges reserved for use by other communications devices may be predetermined and specifically reserved for those communications devices. Processor 204 may be arranged to compare frequencies available for transmission to reserved frequency ranges and finds usable frequencies. Processor 204 may be configured to compare the usable frequencies to the first transmission frequencies 279, and find a second transmission frequency 281 not within the first transmission frequencies 279, but within the usable frequencies. The second transmission frequency 281 may be a frequency within the usable frequencies, but also may be a frequency not used by the first transmission characteristics 255. In this way, processor 204 may be configured to identify spectrum holes.

Upon finding second transmission frequency 281, processor 204 may then be configured to find, using transmission characteristics 241, second transmission characteristics 257 for which second transmission frequency 281 could be paired with. The second transmission characteristics 257 may use characteristics of known transmissions, which are reserved for use by other communications devices. Upon finding second transmission characteristics 257, processor 204 may then convert first communication 250 in a second communication 280 having second transmission characteristics 257 and information 256. Selection of second transmission characteristics 257 may have no relationship to communications device 202, and may be determined base upon the second transmission frequency 281. The second transmission frequency 281 may not be a frequency at which the first communication 250 is traditionally transmitted. In some examples, a communication including audio information may be transmitted via cellular telephone transmissions at a reserved frequency, such as between about 890 MHz and about 915 MHz to send information, and between about 935 MHz and about 960 MHz to receive information, and therefore these reserved frequencies are the frequencies at which cellular telephone transmissions are traditionally transmitted.

Second transmission characteristics 257 may be transmission characteristics for which a communication transmitted at the second transmission frequency 281 can be transmitted with, and are determined using the transmission characteristics 241 stored in database 225. For example, if second transmission frequency 281 is a frequency at which television transmissions are traditionally transmitted, then the second transmission characteristics 257 may include second transmission frequency 281 along with any traditional handshake protocols that the television transmission may use, and in a format traditionally used for television transmissions. Second transmission characteristics 257 may be different from first transmission characteristics 255. Second transmission characteristics 257 may use transmission frequencies not within the first transmission frequency 279, and may use formats not the same as the formats used by first transmission characteristics 255.

Processor 204 may then be configured to instruct transmitter 206 to transmit second communication 280 with second transmission characteristics 257 using second transmission frequency 281. In this manner, cognitive radio 203 is able to transmit a first communication 250 using transmission characteristics different from that traditionally used for first communication 250, disguising first communication 250. As a result, using second transmission characteristics 257 to transmit information 256 traditionally transmitted using first transmission characteristics 255, may make it more difficult for unintended recipients to identify the type of transmission, reducing the likelihood that the unintended recipients will capture communications transmitted via communications device 202.

Communications, such as communications 240, 250, and 280 may include any information, or data, which can be encoded for computer storage and processing purposes, and may include any type of data, such as hexadecimal data, decimal data, binary data, or ASCII character data. The information included in communications 240, 250, 280 can include encoded audio signals, encoded video signals, text, as well as any other type of data.

FIG. 4 depicts a flowchart illustration of methods, apparatus (systems) and computer program products, arranged in accordance with at least some embodiments of the present disclosure. It will be understood that each block of the flowchart illustration in FIG. 4, and combinations of blocks in the flowchart illustration in FIG. 4, can be implemented by, for example, computer program instructions. These computer program instructions may be loaded onto a computer, a processor, or other programmable data processing apparatus to produce a machine, such that the instructions which execute on the computer, the processor, or other programmable data processing apparatus are means for implementing the functions specified in the flowchart block or blocks. These computer program instructions may also be stored in a storage device that can direct a computer or other programmable data processing apparatus to function in a particular manner, such that the instructions stored in the storage device may be an article of manufacture including instructions which implement the function specified in the flowchart block or blocks. The computer program instructions may also be loaded onto a computer or other programmable data processing apparatus to cause a series of operational steps or functional operations to be performed on the computer, the processor or other programmable data processing apparatus to produce a computer implemented process such that the instructions which execute on the computer, the processor, or other programmable apparatus implement the functions specified in the flowchart block or blocks.

Accordingly, blocks of the flowchart illustration in FIG. 4 support combinations of means for performing the specified functions, combinations of steps or operations for performing the specified functions and program instruction means for performing the specified functions. It will also be understood that each block of the flowchart illustration in FIG. 4, and combinations of blocks in the flowchart illustration in FIG. 4, can be implemented by special purpose hardware-based computer systems, such as a cognitive radio, which perform the specified functions or steps, or combinations of special purpose hardware and computer instructions.

Such computer instructions may be fixed either on a tangible medium, such as a computer readable medium (for example, a diskette, CD-ROM, ROM, or fixed disk) or transmittable to a computer system, via a modem or other interface device, such as a communications adapter connected to a network over a medium. The medium may be either a tangible medium (for example, optical or analog communications lines) or a medium implemented with wireless techniques (for example, microwave, infrared or other transmission techniques). The series of computer instructions embodies all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (for example, shrink wrapped software), preloaded with a computer system (for example, on system ROM or fixed disk), or distributed from a server or electronic bulletin board over the network (for example, the Internet or World Wide Web).

Referring to FIG. 4, a method 500 for transmitting a first communication 250, in a secure manner, may be initiated at block 501 according to at least some embodiments of the present disclosure. Upon initiating the method 500 for transmitting a first communication 250 in a secured manner at block 501, processor 204 may be configured to send cognitive instructions, specifically spectrum sensing instructions, to receiver 208 at block 502. The spectrum sensing instructions may be any instruction that helps in accomplishing a spectrum-sensing task. At block 504, receiver 208 may be adapted to receive the spectrum sensing instructions and begin to execute a spectrum-sensing task, where receiver 208 may be configured to scan the RF spectrum for spectrum holes.

Upon finding some spectrum holes, receiver 208 may then be adapted to send spectrum sensing information 270 containing information regarding what spectrum holes are found, back to the processor 204, at block 506. The spectrum sensing information informs the processor 204 of the spectrum holes, indicating which bands of RF frequencies are available for use. Processor 204 may be adapted to retrieve transmission characteristics 241 from database 225, at block 508. Processor 204 may also be configured to receive from input device 215 first communication 250 having information 256 and which is to be transmitted using first transmission characteristics 255 having first transmission frequencies 279, at block 510.

Upon receiving spectrum sensing information 270 and transmission characteristics 241, processor 204 may be configured to determine which frequencies are available for transmission and which frequency ranges are reserved for use by other communications devices, using transmission frequency information 242 within transmission characteristics 241, at block 512. Processor 204 may then be arranged to compare frequencies which are available for transmission to frequency ranges which are reserved and finds usable frequencies, at block 514. The processor 204 may then be arranged to compare the usable frequencies to the first transmission frequencies 279 and finds a second transmission frequency 281 not within the first transmission frequencies 279, but which is within the usable frequencies, at block 516. Processor 204 may then be configured to finds second transmission characteristics 257 which use second transmission frequency 281, at block 518.

Upon finding second transmission characteristics 257, processor 204 may be configured to convert the first communication 250 in a second communication 280 having second transmission characteristics 257 and information 256, at block 520. Processor 204 may then be adapted to instruct transmitter 206 to transmit second communication 280 with second transmission characteristics 257 using available frequency 281, at block 522. In this manner, cognitive radio 203 may be able to transmit first communication 250 using transmission characteristics different from the transmission characteristics traditionally used for first communication 250.

In the preceding description, various aspects of claimed subject matter have been described. For purposes of explanation, specific numbers, systems and/or configurations were set forth to provide a thorough understanding of claimed subject matter. However, it should be apparent to one skilled in the art and having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now, or in the future, occur to those skilled in the art. It is, therefore, to be understood that the appended claims are intended to cover all such modifications and/or changes as fall within the true spirit of claimed subject matter.

Furthermore, in those instances where a convention analogous to “at least one of A, B, and C, etc.” is used, in general such a construction is intended in the sense one having skill in the art would understand the convention (for example, “a system having at least one of A, B, and C” would include but not be to systems that have A alone, B alone, C alone, A and B together, A and C together, B and C together, and/or A, B, and C together, etc.).

While various embodiments have been described, it will be apparent to those of ordinary skill in the art that other embodiments and implementations are possible within the scope of the claimed subject matter. Accordingly, the claimed subject matter is not to be restricted except in light of the attached claims and their equivalents.

1. A method for transmitting a communication, the method comprising:
determining traditional transmission characteristics of a first communication including initial information;
determining a frequency of one or more spectrum holes;
selecting second transmission characteristics different from the traditional transmission characteristics of the first communication; and
transmitting a second communication including the initial information, at the frequency of the one or more spectrum holes, using second transmission characteristics.

2. The method of claim 1, further comprising transmitting the first communication.

3. The method of claim 1, wherein the traditional transmission characteristics are traditional transmission characteristics for cellular telephone transmissions.

4. The method of claim 1, wherein the frequency of the one or more spectrum holes is different from traditional transmission frequencies for cellular telephone transmissions.

5. The method of claim 1, wherein a handshake protocol of the second communication is different from handshake protocols for cellular telephone transmissions.

6. The method of claim 1, wherein a format of the second communication is different from traditional formats for cellular telephone transmissions.

7. The method of claim 1, wherein the determining of the frequency of the one or more spectrum holes is performed by a cognitive radio.

8. The method of claim 1, wherein the transmitting of the second communication is performed by a cognitive radio.

9. The method of claim 1, wherein the determining of the frequency of the one or more spectrum holes is performed by a cognitive radio, and the transmitting of the second communication is performed by the cognitive radio.

10. A computer program product comprising software encoded in computer-readable media, for transmitting a communication with a cognitive radio, the software comprising instructions, operable when executed, to:
determine traditional transmission characteristics of a first communication including initial information;
determine a frequency of one or more spectrum holes;
select second transmission characteristics different from the traditional transmission characteristics of the first communication; and
transmit a second communication including the initial information, at the frequency of the one or more spectrum holes, using second transmission characteristics.

11. The computer program product of claim 10, wherein the software further comprises instructions, operable when executed, to receive the first communication.

12. The computer program product of claim 10, wherein the traditional transmission characteristics are traditional transmission characteristics for cellular telephone transmissions.

13. The computer program product of claim 10, wherein the frequency of the one or more spectrum holes is different from traditional transmission frequencies for cellular telephone transmissions.

14. The computer program product of claim 10, wherein a handshake protocol of the second communication is different from handshake protocols for cellular telephone transmissions.

15. The computer program product of claim 10, wherein a format of the second communication is different from traditional formats for cellular telephone transmissions.

16. A cognitive radio system, comprising:
a cognitive radio, comprising
a transmitter and a receiver, or a transceiver,
a processor, connected to the transmitter and the receiver, or the transceiver, and
storage media having encoded thereon software for transmitting a communication with the cognitive radio,
wherein the software comprises instructions, operable when executed, to: determine traditional transmission characteristics of a first communication including initial information;
determine a frequency of one or more spectrum holes;
select second transmission characteristics different from the traditional transmission characteristics of the first communication; and
transmit a second communication including the initial information, at the frequency of the one or more spectrum holes, using second transmission characteristics.

17. The cognitive radio system of claim 16, wherein the traditional transmission characteristics are traditional transmission characteristics for cellular telephone transmissions.

18. The cognitive radio system of claim 16, wherein the frequency of the one or more spectrum holes is different from traditional transmission frequencies for cellular telephone transmissions.

19. The cognitive radio system of claim 16, wherein a handshake protocol of the second communication is different from handshake protocols for cellular telephone transmissions.

20. The cognitive radio system of claim 16, wherein a format of the second communication is different from traditional formats for cellular telephone transmissions.
